(19) United States
(12) Patent Application Publication
(10) Pub. No.: US 2026/0105529 A1
(43) Pub. Date: Apr. 16, 2026

(54) SYSTEMS AND METHODS FOR A LIFETIME EXCHANGE TRADED FUND

(71) Applicant: ETFinancial, LLC, Scottsdale, AZ (US)

(72) Inventors: Thomas Haines, Westfield, NJ (US); Richard Kado, Scottsdale, AZ (US)

(21) Appl. No.: 19/357,822

(22) Filed: Oct. 14, 2025

Related U.S. Application Data
(60) Provisional application No. 63/707,024, filed on Oct. 14, 2024.

(51) Int. Cl. G06Q 40/08

(52) U.S. Cl. CPC G06Q 40/08

(57) ABSTRACT

Disclosed are various embodiments for systems and method for a lifetime exchange traded fund. Various embodiments can receive at least one of personally identifiable information (PII), cost basis data on shares to be pledged, and income choice. Various embodiments can then calculate an amount of lifetime income. Various embodiments can then send the amount of lifetime income to one of the investor, the financial advisor, or the insurance company. Various embodiments can then generate pledged shares and income reference units (IRUs) and send a notification to trustee to issue IRUs through a clearing house. Then, various embodiments can create the pledged shares associated with an investor and investor profile based on the PII, send the pledged share information to a broker, and send the investor profile, the IRUs, and the pledged share information to an insurer.

### CROSS-REFERENCE TO RELATED PATENT APPLICATION

This application claims priority to and the benefit of the filing date of U.S. Provisional Patent Application No. 63/707,024, filed October 14, 2024, the entirety of which is hereby incorporated by reference herein.

### BACKGROUND

Distributed computing systems tasked with managing complex asset pledging workflows and guaranteed rights across multiple networked entities have encountered significant technical limitations. Conventional approaches lack unified protocols for real-time tracking and reconciliation of dynamic asset states, user elections, event triggers (such as death or transfer), and data objects representing future entitlements. Alternative systems often offer poor interoperability between hardware and software platforms; slow or manual intervention in processing events; unreliable automation for updating or cancelling virtual units that reflect ongoing obligations; fragmented logic for synchronizing multi-source valuation models and contract calculations; and insufficient secure messaging among various devices administering workflow instructions within trust-based architectures. These limitations have hindered efficient orchestration of automated processes required to support robust data integrity, timely event response, and seamless communication among participants in distributed environments.

### BRIEF DESCRIPTION OF THE DRAWINGS

The accompanying drawings, which are incorporated in and constitute a part of the present description serve to explain the principles of the apparatuses and systems described herein:

FIG. 1 shows an example system;

FIG. 2 shows a flowchart of an example method performed by the example system;

FIG. 3 shows a flowchart of an example method performed by the example system;

FIG. 4 shows a flowchart of an example method performed by the example system;

FIG. 5 shows a flowchart of an example method performed by the example system;

FIGS. 6A and 6B show example process flow;

FIG. 7 shows an example process flow;

FIG. 8 shows an example process flow;

FIG. 9 shows an example process flow;

FIG. 10 shows an example process flow;

FIG. 11 shows an example flowchart of an example method performed by the example system.

### DETAILED DESCRIPTION

As used in the specification and the appended claims, the singular forms “a,” “an,” and “the” include plural referents unless the context clearly dictates otherwise. Ranges can be expressed herein as from “about” one particular value, and/or to “about” another particular value. When such a range is expressed, another configuration includes from the one particular value and/or to the other particular value. When values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude other components, integers, or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these cannot be explicitly described, each is specifically contemplated and described herein. This applies to all parts of this application including, but not limited to, steps in described methods. Thus, if there are a variety of additional steps that can be performed it is understood that each of these additional steps can be performed with any specific configuration or combination of configurations of the described methods.

As will be appreciated by one skilled in the art, the methods and systems can take the form of an entirely hardware embodiment, an entirely software embodiment, or an embodiment combining software and hardware aspects. Furthermore, the methods and systems can take the form of a computer program product on a computer-readable storage medium having computer-readable program instructions (e.g., computer software) embodied in the storage medium. More particularly, the present methods and systems can take the form of web-implemented computer software. Any suitable computer-readable storage medium can be utilized including hard disks, CD-ROMs, optical storage devices, magnetic storage devices, memristors, Non-Volatile Random Access Memory (NVRAM), Random Access Memory (RAM), flash memory, or a combination thereof.

Throughout this application reference is made to block diagrams and flowcharts. It will be understood that each block of the block diagrams and flowcharts, and combinations of blocks in the block diagrams and flowcharts, respectively, can be implemented by processor-executable instructions. These processor-executable instructions can be loaded onto a general-purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions can also be stored in a computer-readable memory that can direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions can also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Accordingly, blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, can be implemented by special purpose hardware-based computer systems that perform the specified functions or steps, or combinations of special purpose hardware and computer instructions.

This detailed description can refer to a given entity performing some action. It should be understood that this language can in some cases mean that a system (e.g., a computer) owned and/or controlled by the given entity is actually performing the action.

Lifetime Income ETF may be organized as an exchange-traded fund that can issue shares (“Shares”) that can trade on a national stock market exchange in the same manner as conventional exchange-traded fund (“ETF”) shares. The offering of the Lifetime Income ETF may involve various unique features. For example, the investment return on the Fund’s Shares can be based on the performance of multiple registered index-linked annuity contracts (“RILAs” or “RILA contracts”) held in the Trust. Because the Fund’s Shares may trade in the secondary markets, investors may have the ability to obtain RILA returns on an enhanced liquidity basis, i.e., at intra-day prices, as compared to RILAs that ordinarily are offered and sold by insurers on a subscription-way basis and priced only once a day. In at least another example, the investment return on the Fund’s Shares can be based on the performance of one or more privately placed index-linked annuities. In another example, the Lifetime Income ETF may be offered as part of a program (“Program”) that can provide Fund investors who are natural persons and either U.S. citizens or permanent residents (collectively, “Shareholders”) with the ability to pledge their Shares in return for specified levels of monthly lifetime income. In at least some embodiments, the Lifetime Income ETF can also include fund investors as “token holders,” who own units in the Lifetime Income ETF rather than discrete shares. Token holders may have received tokens of the Lifetime Income ETF by trading over a blockchain. Tokens represent a claim to an ETF share, but is not the share itself. Depending on how the token offering is setup, the token holder may have identical rights or substantially similar rights to a Shareholder. For brevity purposes, any further reference to Shareholders can also include token holders and any further discussion of Shares may also be represented as tokens.

Under the Program, Shareholders can start receiving monthly income payments, i.e., “activate” income, any day beginning five years after the initial listing date of the Shares, within certain age and duration limits. Under the Program, pledged Shares may be redeemed in amounts sufficient to provide the monthly income payments, and once they are fully redeemed the monthly payments may be funded by guaranteed lifetime withdrawal benefits (“GLWBs”) available under the RILAs. Shareholders may continue to participate in the investment experience of the pledged Shares prior to their redemption. In addition, Shareholders may have the ability to cease receiving monthly income payments (or decide not to take them at all) by un-pledging any Shares that have not been redeemed by simply selling their pledged Shares in the secondary market. Shareholders, therefore, may have the ability under the Program to receive and manage monthly lifetime income payments without purchasing an annuity, as explained further below.

The Fund may be a sub-trust (“Sub-Trust 1”) of a unit investment trust (“UIT”), called the “Super Trust.” The Super Trust may be organized pursuant to a Declaration of Trust, which would govern the structure and operations of the Super Trust and each of its sub-trusts (“Sub-Trusts”). In addition to the Fund, the Super Trust may consist of two other Sub-Trusts, namely, Sub-Trust 2 and Sub-Trust 3. Sub-Trust 2 may facilitate the payment of monthly lifetime income payments to Shareholders who wish to activate income by pledging their Shares. Sub-Trust 2 may pay income payments first by redeeming pledged Shares, and then by using amounts funded by GLWB benefits under the RILA contracts (“GLWB Interests”). Sub-Trust 3 may acquire and maintain multiple RILA contracts and assign different economic rights thereunder to the Fund and to Sub-Trust 2. Sub-Trust 3 may assign the economic rights to the account value of the RILA contracts (“Account Value Interests”) exclusively to Sub-Trust 1 (the Fund) in exchange for cash from the Fund. As a result, the Fund’s investment experience may be based on the performance of the Account Value Interests. Sub-Trust 3 may assign the economic rights to the GLWB Interests exclusively to Sub-Trust 2 to fund monthly lifetime income payments to Shareholders of the Fund. The Lifetime Income ETF may only issue new Shares to authorized participants for the first ten years following its listing date. However, investors may purchase and sell Shares through their broker-dealers on the secondary market in perpetuity, as long as the Shares continue to be eligible for exchange listing.

The daily net asset value (“NAV”) of Fund Shares can be based upon the valuation of the Account Value Interests that it holds as well as any necessary cash for Fund management purposes. The insurers issuing the RILA contracts (“Insurers”) may calculate a daily unit valuation of each RILA contract. The daily unit valuation can be calculated in various ways. For example, a RILA contract can be structured such that the market value of the contract’s segregated accounts and the value of the index accounts are based on the Black Scholes option pricing model. For another example, in various embodiments, the daily unit valuation can be calculated using two market value adjustment (“MVA”) formulas: Interest Rate MVA and Equity Index MVA. Regarding Interest Rate MVA, for the first term of years (e.g., 15 years) after a Fund’s listing date, the RILA contracts can apply an interest rate MVA that can replicate the valuation of a zero-coupon corporate bond based upon observing a major market index provider’s bond index yield. After the first term of years (e.g., year 15), an interest rate MVA can cease to be applied. Regarding the equity index MVA, the RILA contracts can provide partial upside participation with partial downside protection for a series of twelve S&P 500 crediting strategies. In various embodiments, the Insurers can value these index strategies daily using a formulaic Black Scholes Option pricing model. In various embodiments, the value of the Account Value Interests can be the basis for the valuation of the Fund’s creation and redemption baskets.

The sale of Fund Shares through creation baskets may be halted after a second term of years (e.g., after the 10th year) of the corresponding Super Trust, but investors may continue to purchase and sell Fund Shares through their broker-dealers in the secondary market throughout the Fund’s entire lifecycle. A Super Trust may remain open until all Shareholders that have activated lifetime income are deceased. (Broker-dealers and custodians may be required to notify the Trustee of a death.) The Fund may remain listed until the sooner of when the Super Trust closes or when there is less than some applicable amount (e.g., $2 million or another applicable amount) remaining in the Fund. The redemption proceeds of any Shares remaining after the Fund delists can be returned to the remaining investors.

The Trustee of the Super Trust may administer the Program in accordance with the Declaration of Trust. The sale of Fund Shares through creation baskets may be halted after a period of time (e.g., the 10th year) of the corresponding Super Trust, but investors may continue to purchase and sell Fund Shares through their broker-dealers in the secondary market throughout the Fund’s entire lifecycle. A Super Trust may remain open until all Shareholders that have activated lifetime income are deceased. The Fund may remain listed until the sooner of when the Super Trust closes or when there is less than $2 million (or other applicable amount) remaining in the Fund. The redemption proceeds of any Shares remaining after the Fund delists can be returned to the remaining investors.

Sub-Trust 1 may sell Shares of the Fund to financial institutions acting as “authorized participants” in large blocks of Shares called “creation baskets.” Sub-Trust 1 may transfer the proceeds of such sales to Sub-Trust 3. Sub-Trust 3 may use the cash received from the sale of creation baskets to buy RILA contracts. Sub-Trust 3 may hold and manage the RILA contracts and may assign different economic interests therein to Sub-Trust 1 and Sub-Trust 2, as described above. Authorized participants that purchase enough Shares in the secondary market to aggregate a block of Shares called a “redemption basket” may redeem those Shares directly back to the Lifetime Income ETF. To pay the authorized participant for the redemption of the redemption basket, Sub-Trust 1 may return an appropriate amount of Account Value Interests to Sub-Trust 3 in exchange for cash. To obtain the cash, Sub-Trust 3 may surrender a sufficient amount of account value from a RILA contract and pay the proceeds to the Fund.

Lifetime Income ETF Shareholders may activate monthly lifetime income by pledging a certain amount of Shares to the Trustee. Each month, the Trustee may redeem a sufficient amount of pledged Shares at NAV to provide monthly income payments to Shareholders. The redemptions may occur in the same manner as redemption baskets, with Sub-Trust 1 (the Fund) returning an amount of Account Value Interests to Sub-Trust 3 in exchange for cash, which Sub-Trust 3 may generate by redeeming account value from a RILA contract. Once all pledged shares have been redeemed, monthly lifetime income payments may be funded by GLWB Interests. Sub-Trust 2, which holds the GLWB Interests, may receive GLWB payments from the Insurers and the Trustee may use these proceeds to continue paying monthly income payments to the Shareholder for the remainder of his or her life.

Shareholders may activate monthly lifetime income on any day five years after the initial listing date of the Fund’s Shares, within certain age and duration limits. A Shareholder can buy a certain level of lifetime guaranteed income by pledging a corresponding amount of Shares. The pledged Shares can remain in the Shareholder’s brokerage account until sold by the Shareholder in the secondary markets or redeemed to pay for monthly income.

When Shares are pledged for income, the Trustee can calculate the amount of monthly lifetime income that corresponds to the pledged Shares. This amount may be tracked by a unit of measure called the Income Reference Unit (“IRU”), which Sub-Trust 2 may issue to the Shareholder. Each IRU represents one dollar of guaranteed lifetime income, and each IRU has a zero net asset value. The number of IRUs that a Shareholder receives may depend on the amount of Shares pledged. To generate monthly lifetime income payments, the Trustee may redeem pledged Shares on behalf of the Fund at the Shares’ daily NAV. As pledged Shares are redeemed, the number of IRUs that a Shareholder holds does not decrease. If at any point a Shareholder changes his or her mind and no longer wishes to receive lifetime income payments, the Shareholder may sell any remaining pledged Shares through his or her broker-dealer, in which case the corresponding IRUs may be cancelled. After all of a Shareholder’s pledged Shares have been redeemed, monthly lifetime income payments may continue to be paid for the rest of the individual’s life.

Like other exchange-traded funds (“ETFs”), the Lifetime Income ETF may not sell or redeem individual Shares (except for monthly income as described above). Instead, “authorized participants” that have contractual arrangements with the Lifetime Income ETF (or its distributor) may purchase and redeem the Fund’s Shares directly from and to the Fund in blocks called “creation baskets” or “redemption baskets.” Like most ETFs, the Lifetime Income ETF may charge authorized participants a nominal creation/redemption fee. Shares issued by the Lifetime Income ETF may trade on a nationally recognized stock exchange, have intra-day values, and may be bought and sold in the same manner as publicly traded stocks. Investors may buy or sell Shares on the secondary market by placing buy or sell orders with their broker-dealers. There are no age restrictions on the purchase of Shares.

At each such income activation event, the Shareholder may be issued corresponding IRUs. IRUs are unlisted shares issued by Sub-Trust 2 that correspond to a Shareholder’s level of guaranteed lifetime income payments. In various embodiments, the number of IRUs issued to a Shareholder can equal the amount of annual income that has been activated. Each IRU may be cross-referenced to the specific Shares that are pledged to activate the income. Shares may be pledged at different times. IRUs entitle a Shareholder to monthly income payments, which Sub-Trust 2 can pay. Each IRU may entitle the Shareholder to $1 of annual income, prorated over 12 months. This monthly distribution may be taxed as ordinary income. The asset value of each IRU may be zero, and in that regard an IRU may serve simply to represent units of guaranteed income. While IRUs may not be listed or traded, IRUs may receive a CUSIP number to facilitate communication with a Shareholder’s broker-dealer. IRUs may be NSCC/DTCC settled like other unlisted funds, except that as noted above IRUs may have a zero-face value.

By way of example, if a Fund Shareholder is issued and owns 1,000 IRUs, that Shareholder may receive annual income payments equal to $1,000 that is prorated and distributed monthly. IRUs are static once issued. The payments may only change upon three events:

• If an IRU holder sells their pledged Shares on the secondary market through their broker-dealer. This may force a cancellation of IRUs tagged to those Shares;

• The death of a Shareholder (or second death if there is joint ownership). This may result in the cancellation of all corresponding IRUs and thus terminate lifetime income. Note that any remaining pledged Shares may be “un-pledged,” and remain in the Shareholder’s estate; and/or

• The closure/termination of the Super Trust upon the death of all Shareholders who have activated income or if the Shares no longer meet listing standards. This is a failsafe provision if the Super Trust is closed. Any income obligations to Shareholders who have pledged Shares may be fulfilled by exchanging any remaining pledged Shares for a single premium deferred annuity, or “SPIA,” issued by an insurance company providing the same amount of income.

A RILA is one of several types of annuity contracts offered by insurance companies. A RILA investor’s gains or losses are based on whether a selected benchmark, typically an index, goes up or down over a set period of time. RILAs also have a “bounded return structure,” meaning that they may usually limit an investor’s losses through a “buffer” or “floor” when the index goes down, but at the cost of limiting that investor’s gains when the index goes up through the application of a “participation rate” or “cap rate.” The RILA contracts held by Sub-Trust 3 may provide a 100% floor to the index’s return over a rolling one-year period with an upside participation rate. Each RILA contract may have a GLWB feature that may provide guaranteed lifetime income payments in addition to upside appreciation potential and downside protection. RILA GLWB features guarantee that if predetermined income payments are taken, and the account value of the RILA contract supporting those payments is depleted while the Shareholder is still living, the insurance company may continue paying lifetime income payments out of its general account assets. Each RILA contract with a GLWB feature may therefore be viewed as consisting of two separate interests – an account value component and a guaranteed lifetime income component when account value runs out.

Example #1: Jane has $350000 in a former 401k plan that has rolled to an IRA. Assuming the Current Lifetime Income ETF is trading at $26.20, Jane can purchase 13,359 shares ($26.20 times 13,359 shares = $350005.80). After fifteen years, Jane retires. To activate income, Jane pledges all of his or her shares now worth $47.18 per share, totaling $630277.62). The financial institution calculates the lifetime income for Jane at 7.8%, which would result in $49,161 per year ($630277.62 times 0.078), or a monthly income of $4,096 ($630277.62 times 0.078 divided by 12). Jane also receives 49,161 IRUs at the time of activation. Every month, Jane may receive $4,096 as a result of the trustee redeeming $4096 worth of his or her ETF shares at the daily Net Asset Value (NAV). Once all 13,359 of the pledged shares are redeemed, Jane continues to hold the IRU shares and may continue to receive $4,096 monthly income until he or she dies. Upon death, the IRU shares are redeemed.

Example #2: Bob is 65 and Linda is 63. Bob and Linda have rolled their 401k proceeds into a joint IRA with a total of $650000. Assuming the Current Lifetime Income ETF is trading at $26.20, the advisor (FA) can purchase 24,809 shares of the ETF. When Bob is 78 and Linda is 76, the advisor pledges all their shares that are now worth $47.18/share. Their lifetime income factor is calculated as 6.5% giving them a guaranteed income until their combined second death, of $76,082 and a monthly income of $6,340.17. Bob and Linda receive 76,082 IRUs and every month the trustee may redeem $6,340.17 worth of the Lifetime Income ETF Trust’s shares at their Net Asset Value. Bob passes away when he is 85 and Linda continues to receive the monthly income until her passing many years later. Once all of Linda’s pledged accumulation shares are redeemed, she may continue to hold her IRUs and receive $6,340.17 of monthly income until she dies. At Linda’s death, the IRUs are redeemed at their Zero NAV.

Systems operating in distributed computing environments have historically struggled to synchronize event-driven workflows and stateful data objects across heterogeneous nodes responsible for managing asset pledging, entitlement activation, and conditional rights revocation. In prior solutions, asynchronous processing pipelines and manual interventions often led to delayed updates, missed triggers during lifecycle events (such as death or transfer), loss of referential integrity between virtual units representing future entitlements and their underlying assets, and unreliable propagation of account changes among independent hardware or software platforms. These limitations resulted in persistent problems including inconsistent reconciliation of pledged resources; fragmented communication between endpoint devices; inability to reliably automate cancelation or modification actions upon occurrence of external events; difficulty scaling logic for multi-party elections; and error-prone synchronization between asset valuation systems employing diverse computational models.

The disclosed systems introduce technical improvements by leveraging coordinated message passing protocols, automated event monitoring mechanisms, dynamic mapping between physical asset representations (e.g., shares) and virtual entitlement objects (e.g., income reference units), as well as rule-based logic engines capable of executing context-sensitive instructions in response to time-sensitive triggers originating from user inputs or external databases. Unlike conventional architectures reliant on isolated manual processing steps or batch updates, these methods enable real-time orchestration of pledging workflows, which reconcile cost basis values, user elections (single/joint), redemption requests, entitlement adjustments following detection of death indices, as well as propagate corresponding changes throughout a distributed network without relying on legacy intermediary actors. The design implements robust audit trails using secure messaging frameworks across broker devices, trustee processors, insurer nodes and clearing house interfaces, all of which are synchronized programmatically through flow control structures. As a result of these technological innovations, the invention achieves substantial improvements over existing distributed computing practices in this domain. This ensures reliable data integrity during life-cycle transitions while reducing latency arising from manual interventions or platform interoperability failures, yielding technical advantages that facilitate efficient resource management within complex trust networks not previously attainable by generic computerized financial record-keeping alone.

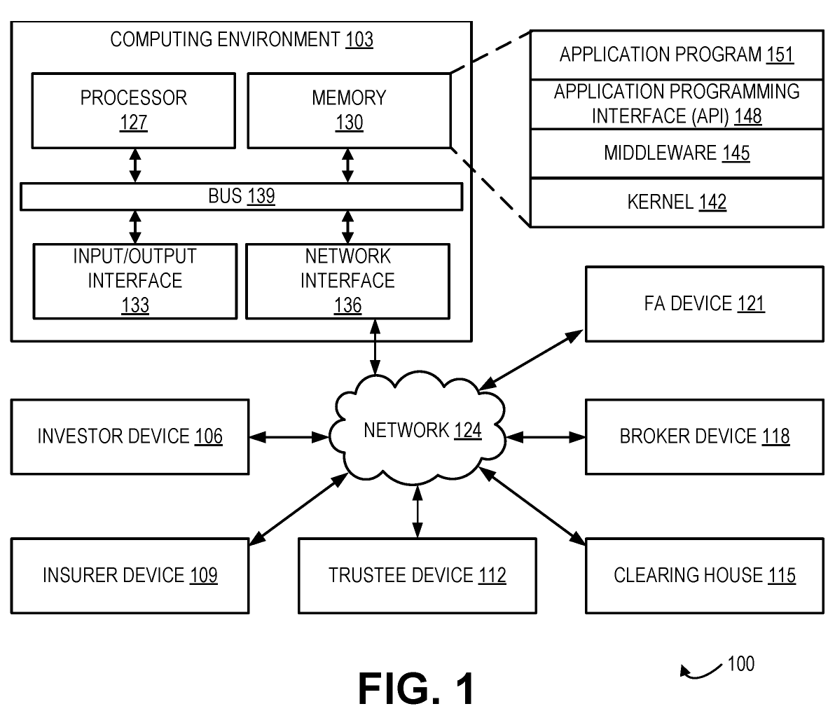

With reference to FIG. 1, shown is a network environment 100 according to various embodiments. The network environment 100 can include a computing environment 103, an investor device 106, an insurer device 109, a trustee device 112, a clearing house device 115, a broker device 118, and a Financial Advisor (FA) device 121, which can be in data communication with each other via a network 124.

The network 124 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI^{®}), BLUETOOTH^{®} networks, microwave transmission networks, as well as other networks relying on radio broadcasts. The network 124 can also include a combination of two or more networks 124. Examples of networks 124 can include the Internet, intranets, extranets, virtual private networks (VPNs), and similar networks.

The computing environment 103 can include one or more computing devices. For example, the computing devices can be configured to perform computations on behalf of other computing devices or applications. As another example, such computing devices can host and/or provide content to other computing devices in response to requests for content. In various embodiments, the computing environment can include a processor 127, a memory 130, an input/output (IO) interface 133, and/or a network interface 136, in data connection with each other over a bus 139 or over the network 124. Moreover, the computing environment 103 can employ a plurality of computing devices that can be arranged in one or more server banks or computer banks or other arrangements. Such computing devices can be located in a single installation or can be distributed among many different geographical locations. For example, the computing environment 103 can include a plurality of computing devices that together can include a hosted computing resource, a grid computing resource, or any other distributed computing arrangement. In some cases, the computing environment 103 can correspond to an elastic computing resource where the allotted capacity of processing, network, storage, or other computing-related resources can vary over time.

The bus 139 can include a circuit for connecting the bus 139, the processor 127, the memory 130, the network interface 136, and the input/output interface 133 to each other and for delivering communication (e.g., a control message and/or data) between the bus 139, the processor 127, the memory 130, the network interface 136, and the input/output interface 133.

The processor 127 can include one or more of a Central Processing Unit (CPU), an Application Processor (AP), and a Communication Processor (CP). The processor 127 can control, for example, at least one of the bus 139, the memory 130, the network interface 136, and the input/output interface 133 of the computing environment 103 and/or can execute an arithmetic operation or data processing for communication. The processing (or controlling) operation of the processor 127 according to various embodiments is described in detail with reference to the following drawings.

The processor-executable instructions executed by the processor 127 can be stored and/or maintained by the memory 130. The memory 130 can include a volatile and/or non-volatile memory. The memory 130 can comprise random-access memory (RAM), flash memory, solid state or inertial disks, or any combination thereof. The memory 130 can store, for example, a command or data related to at least one of the bus 139, the processor 127, the memory 130, the network interface 136, and the input/output interface 133 of the computing environment 103. As an example, the memory 130 can store a software and/or a program. The program can include, for example, a kernel 142, a middleware 145, an Application Programming Interface (API) 148, and/or an application program (or an “application”) 151, or the like, configured for controlling one or more functions of the server computing device 101 and/or an external device. At least one part of the kernel 142, middleware 145, or API 148 can be referred to as an Operating System (OS). The memory 130 can include a computer-readable recording medium having a program recorded therein to perform the method according to various embodiment by the processor 127.

The kernel 142 can control or manage, for example, system resources (e.g., the bus 139, the processor 127, the memory 130, etc.) used to execute an operation or function implemented in other programs (e.g., the middleware 145, the API 148, or the application program 151). Further, the kernel 142 can provide an interface capable of controlling or managing the system resources by accessing individual constitutional elements of the computing environment 103 in the middleware 145, the API 148, and/or the application program 151.

The middleware 145 can perform, for example, a mediation role so that the API 148 or the application program 151 can communicate with the kernel 142 to exchange data. Further, the middleware 145 can handle one or more task requests received from the application program 151 according to a priority. For example, the middleware 145 can assign a priority of using the system resources (e.g., the bus 139, the processor 127, or the memory 130) of the computing environment 103 to at least one of the application programs 151. For example, the middleware 145 can process the one or more task requests according to the priority assigned to the at least one of the application programs, and thus can perform scheduling or load balancing on the one or more task requests.

The Application Programming Interface (API) 148 can include at least one interface or function (e.g., instruction), for example, for file control, window control, video processing, or character control, as an interface capable of controlling a function provided by the application program 151 in the kernel 142 or the middleware 145.

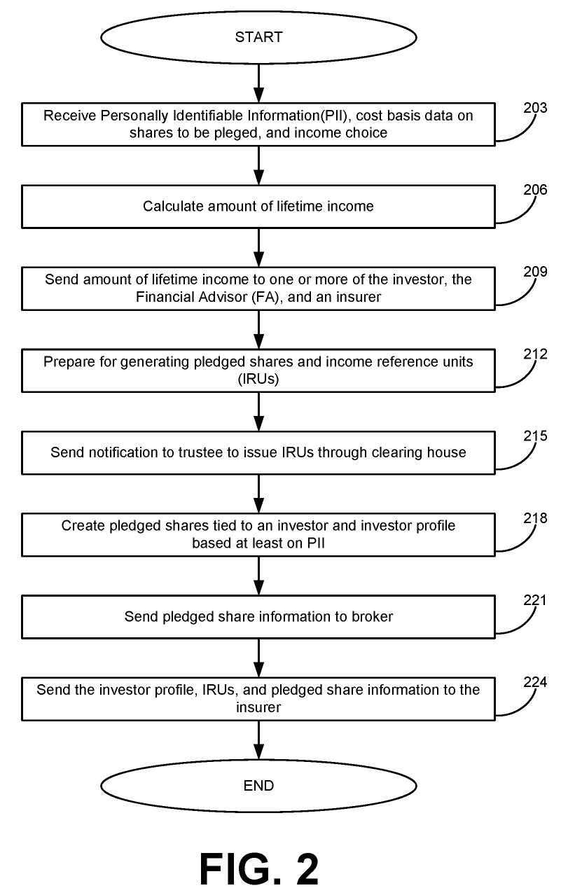

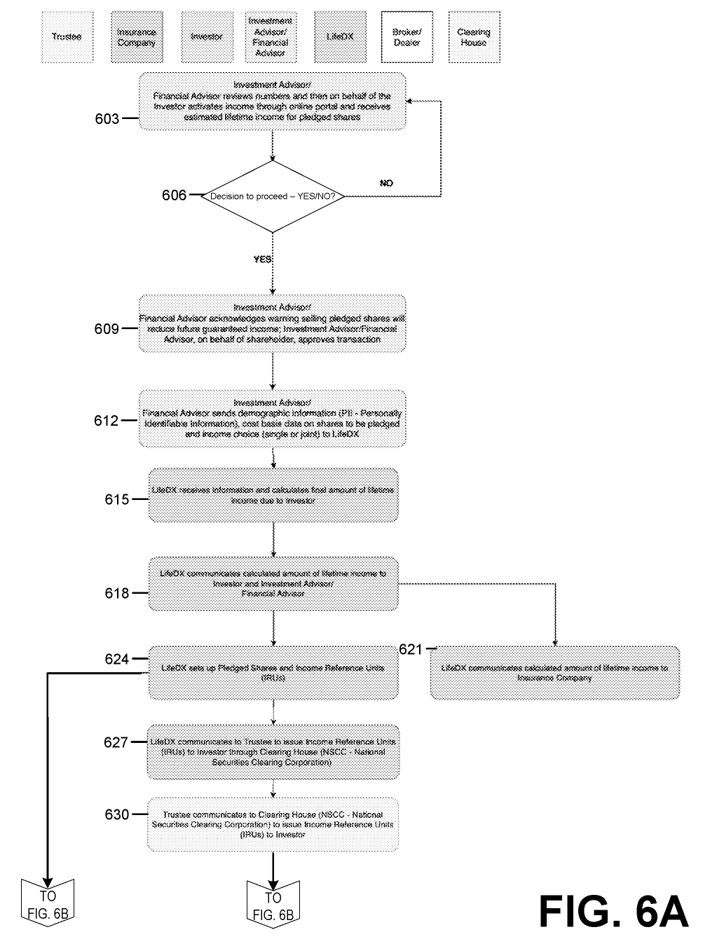

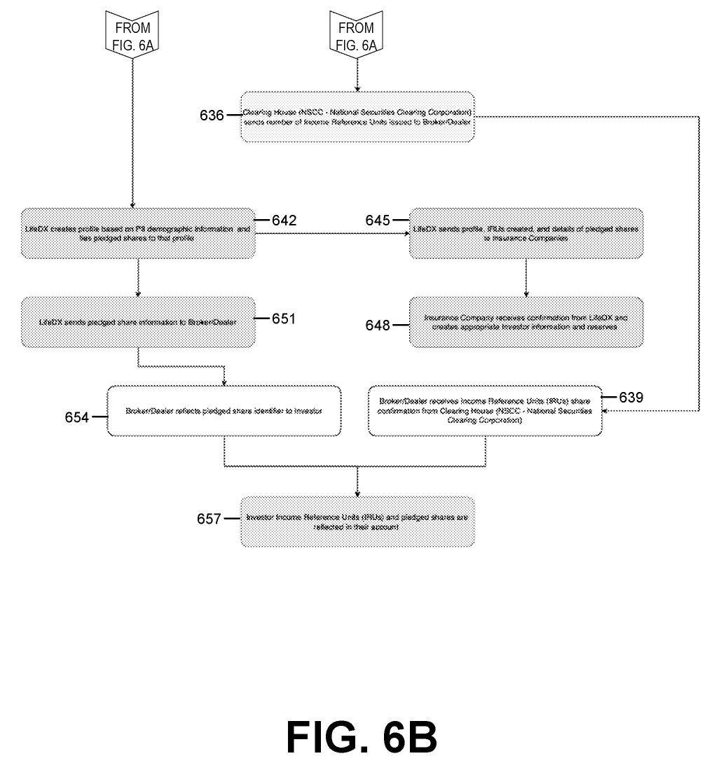

The application program 151 can include logic (e.g., hardware, software, firmware, etc.) that can be implemented to perform any of the functionality described in the corresponding discussions of any of FIGS. 2-5 and 11. Alternatively, the application program 151 can be described as causing any of the functionality depicted in FIGS. 6A, 6B, and/ 7-10 to be performed by the computing environment 103 or any other device devices (e.g., an investor device 106, an insurer device 109, a trustee device 112, a clearing house device 115, a broker device 118, a FA device 121, or other computing devices).

The input/output interface 133 can include an interface for delivering an instruction or data input from a user (e.g., an operator of the computing environment 103) or from a different external device (e.g., an investor device 106, an insurer device 109, a trustee device 112, a clearing house device 115, a broker device 118, a FA device 121, or other computing devices) to the different elements of the computing environment 103. The input/output interface 133 can further include an interface for outputting one or more user interfaces to the user. For example, the input/output interface 133 can comprise a display, such as a touch screen display, and/or one or more physical input interfaces (e.g., keyboard, mouse, etc.) configured to receive user inputs. Further, the input/output interface 133 can output an instruction or data received from one or more elements of the computing environment 103 to one or more external devices (e.g., an investor device 106, an insurer device 109, a trustee device 112, a clearing house device 115, a broker device 118, a FA device 121, or other computing devices).

The network interface 136 can establish, for example, communication between the computing environment 103 and one or more external devices (e.g., an investor device 106, an insurer device 109, a trustee device 112, a clearing house device 115, a broker device 118, a FA device 121, or other computing devices). For example, the network interface 136 can communicate with the one or more external devices (e.g., an investor device 106, an insurer device 109, a trustee device 112, a clearing house device 115, a broker device 118, a FA device 121, or other computing devices) by being connected to the network 124 through wireless communication or wired communication. The network interface 136 can be configured to communicate with the one or more external devices (e.g., an investor device 106, an insurer device 109, a trustee device 112, a clearing house device 115, a broker device 118, a FA device 121, or other computing devices) via the network 124 (e.g., Internet, LAN, etc.). In an example, the network interface 136 can be configured to access the network 124 via a wireless communication interface such as a cellular communication protocol. The cellular communication protocol can comprise at least one of Long-Term Evolution (LTE), LTE Advance (LTE-A), Code Division Multiple Access (CDMA), Wideband CDMA (WCDMA), Universal Mobile Telecommunications System (UMTS), Wireless Broadband (WiBro), Global System for Mobile Communications (GSM), and the like. In an example, the wireless communication interface can be configured to use a near-distance communication. The near-distance communication interface can include for example, at least one of Wireless Fidelity (WiFi), Bluetooth, Bluetooth Low Energy (BLE), Near Field Communication (NFC), Global Navigation Satellite System (GNSS), and the like. According to a usage region or a bandwidth or the like, the GNSS can include, for example, at least one of Global Positioning System (GPS), Global Navigation Satellite System (GLONASS), BeiDou Navigation Satellite System (BDS), Galileo, the European global satellite-based navigation system, and the like. Hereinafter, the “GPS” and the “GNSS” can be used interchangeably in the present document.

The computing environment 103 can include one or more databases. In one example, the one or more databases can comprise one or more relational databases that use structured query language (SQL) for storing and processing data. In another example, the one or more databases can comprise one or more non-relational databases that use non-structured query language (NoSQL) for storing and processing data.

Each of the investor device 106, insurer device 109, trustee device 112, clearing house device 115, broker device 118, and FA device 121 can include its own respective processors, memories, input/output interfaces, network interfaces, busses, with the necessary hardware and/or software to perform the corresponding functionality described in FIGS. 1-5. Alternatively, each of the investor device 106, insurer device 109, trustee device 112, clearing house device 115, broker device 118, and FA device 121 can perform the respective functionality described in FIGS. 6A, 6B, and 7-10.

In various embodiments, an investor device 106 can represent the end-user investor that may benefit from the purchase, sale, and lifetime benefits of the lifetime ETF. The investor device 106 can display notifications to the investor and include various user interfaces to allow the investor to communicate with the broker to pledge shares, communicate with the broker to initiate the sale of pledged shares, direct the computing environment 103 and other computing devices to pledge shares, initiate the sale of pledged shares, and notify a broker about the death of the investor.

Alternatively, in other various embodiments, an investor device 106 can represent a bank account, brokerage account, or other financial account associated with an investor, but physically maintained by a bank or other financial institution. In such embodiments, the investor device 106 is simply a representation of the investor’s legal and/or financial embodiment as enacted by an agent, fiduciary, or representative.

The insurer device 109 represents an insurer that can provide various insurance products, such as annuities, life benefits, and various other insurance products. In various embodiments, the insurer device 109 can notify the insurer to prepare a guaranteed lifetime withdrawal benefit, which provides the investor with a guaranteed stream of income that can be withdrawn for the rest of the investor’s life, which helps protect against the risk of outliving one’s retirement savings.

The trustee device 112 can represent the device of a trustee, an individual or organization appointed to manage and oversee assets or property held in a trust on behalf of the beneficiaries (e.g., the investor, an investment fund, etc.). In various embodiments, the trustee device 112 can receive notifications to establish a trust, notify the beneficiaries of actions being taken upon the trust, transfer property (e.g., obtain, receive, sell, export, etc.), and various other actions.

The clearing house device 115 (shortened as “clearing house 115”) can represent the device of a clearing house, which is an intermediary individual or organization that facilitates the settlement of trades and ensures that transactions between buyers and sellers are completed securely. In various embodiments, the clearing house device 115 can confirm and/or validate trades of property, manage settlement of funds, delivery of assets, monitor risk and/or various other actions.

The broker device 118 can represent the device of a dealer or broker, a person who acts as an intermediary in the buying and selling of financial products. In various embodiments, the broker device 118 can communicate with the investor device 106 to determine whether the investor wishes to take an action, such as activating their income benefits and/or selling shares in the financial product.

The FA device 121 can represent a device of a Financial Advisor (FA), who provides investment advice and financial planning services to investors.

Referring next to FIG. 2, shown is a flowchart that provides one example of the operator of a portion of the application program 151 according to various embodiments of the present disclosure. The flowchart of FIG. 2 provides merely an example of the many different types of functional arrangements that can be employed to implement the operation of the depicted portion of the application program 151. As an alternative, the flowchart of FIG. 2 can be viewed as depicting an example of elements of a method implemented within the network environment 100.

Beginning with block 203, the application program 151 can receive at least one of personally identifiable information (PII), cost basis data on shares to be pledged, and income choice. PII can include identification information about an investor. The cost basis of the shares can include the cost of the shares on the day the shares are to be activated for the income activation. The cost basis can also include the cost at which any of the shares were purchased. The income choice can include an election of a single individual basis (a single person activating their shares) or a couple basis (two persons activating their shares). Because the expected period of time for two persons to become deceased may be longer than a single person, this election may affect the following calculations

Next, at block 206, application program 151 can calculate an amount of lifetime income. In various embodiments, the amount of lifetime income can be calculated based on a variety of factors, including the personally identifiable information, the income choice, the cost of the shares on the day they are to be activated, the cost of the shares when they were purchased, and various other factors. In some embodiments, the amount of lifetime income can represent a percentage of the total amount of the pledged ETF shares. In at least some embodiments, the lifetime income can be a flat yearly or monthly monetary value.

Continuing to block 209, application program 151 can send the amount of lifetime income to at least one of the investor, the FA, or the insurer. In various embodiments, one of the investor, the FA, or the insurer can then review the amount of lifetime income to approve that the amount meets a fair calculation based on the inputs.

Next, at block 212, application program 151 can prepare to generate pledged shares and income reference units (IRUs). In various embodiments, the application program 151 can determine the number of IRUs based on the calculated amount of lifetime income. In various embodiments, the application program 151 can allocate necessary resources and/or establish necessary connections to generate the pledged shares and IRUs. Continuing to block 215, application program 151 can send a notification to trustee to issue IRUs through a clearing house.

Next, at block 218, application program 151 can create the pledged shares associated with an investor and investor profile based on the PII. In various embodiments, the shares owned by the investor that they wish to pledge can become pledged shares, which indicates that those shares if sold or transferred by the investor may impact the ownership of IRUs and thus future lifetime income. Continuing to block 221, application program 151 can send the pledged share information to a broker; and finally, at block 224, application program 151 can send the investor profile, the IRUs, and the pledged share information to an insurer.

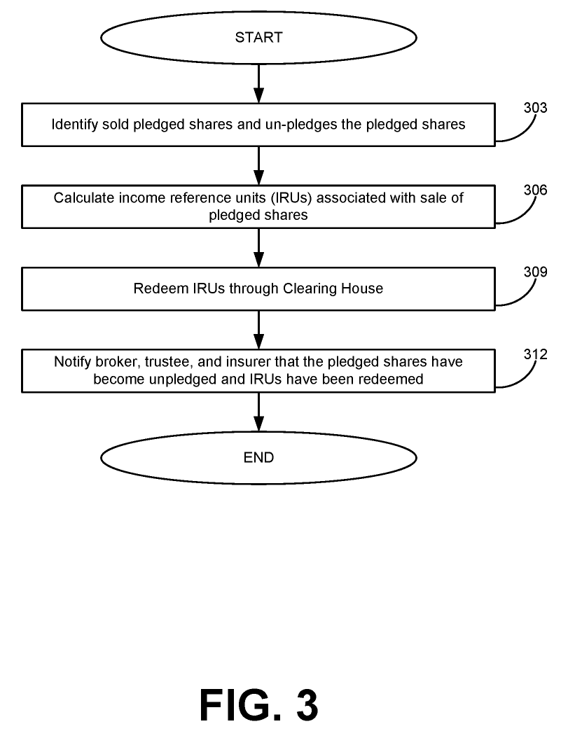

Referring next to FIG. 3, shown is a flowchart that provides one example of the operator of a portion of the application program 151 according to various embodiments of the present disclosure. The flowchart of FIG. 3 provides merely an example of the many different types of functional arrangements that can be employed to implement the operation of the depicted portion of the application program 151. As an alternative, the flowchart of FIG. 3 can be viewed as depicting an example of elements of a method implemented within the network environment 100.

Beginning with block 303, the application program 151 can identify sold pledged shares from the trustee and un-pledges those shares. Next, at block 306, application program 151 can calculate IRUs associated with the sale of the pledged shares. Continuing to block 309, application program 151 can redeem the IRUs through a clearing house. Finally, at block 312, application program 151 can notify one or more of a broker, a trustee, and an insurer that the pledged shares have become unpledged and the IRUs have been redeemed.

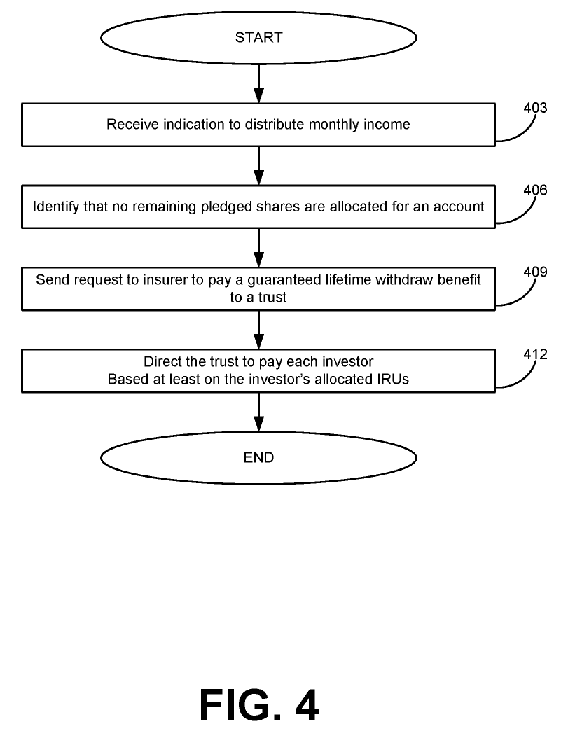

Referring next to FIG. 4, shown is a flowchart that provides one example of the operator of a portion of the application program 151 according to various embodiments of the present disclosure. The flowchart of FIG. 4 provides merely an example of the many different types of functional arrangements that can be employed to implement the operation of the depicted portion of the application program 151. As an alternative, the flowchart of FIG. 4 can be viewed as depicting an example of elements of a method implemented within the network environment 100.

Beginning with block 403, the application program 151 can receive an indication to distribute monthly income to the investor. Next, at block 406, application program 151 can identify that no remaining pledged shares are allocated for an account. Continuing to block 409, the application program 151 can send a request to an insurer to pay a guaranteed lifetime withdraw benefit to a trust. Finally, at block 412, application program 151 can direct the trust to pay each investor based at least on the investor’s allocated IRUs.

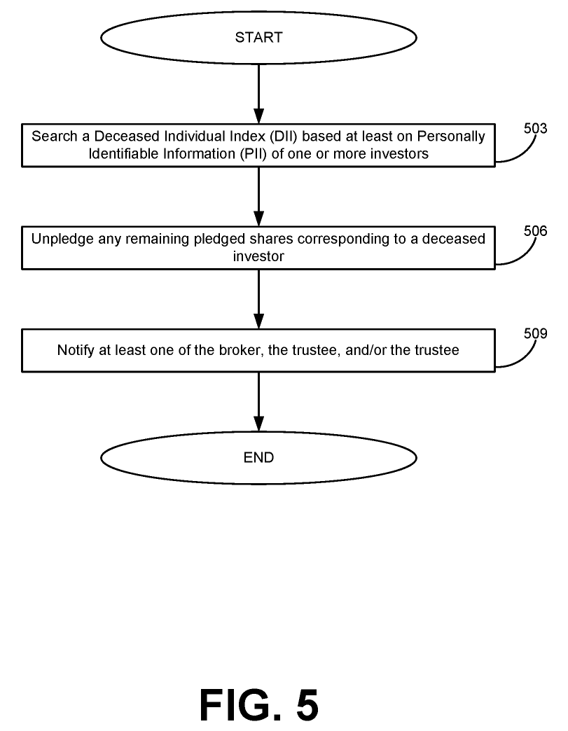

Referring next to FIG. 5, shown is a flowchart that provides one example of the operator of a portion of the application program 151 according to various embodiments of the present disclosure. The flowchart of FIG. 5 provides merely an example of the many different types of functional arrangements that can be employed to implement the operation of the depicted portion of the application program 151. As an alternative, the flowchart of FIG. 5 can be viewed as depicting an example of elements of a method implemented within the network environment 100.

Beginning with block 503, the application program 151 can obtain information indicating that an investor has become a deceased investor. In various embodiments, the application program 151 can search a deceased individual index (DII) based at least on personally identifiable information (PII) of one or more investors. In various embodiments, the application program 151 can receive a notification from a broker device 118 indicating that an investor has become deceased. Next, at block 506, application program 151 can unpledged any remaining pledged shares corresponding to the deceased investor. Finally, at block 509, application program 151 can notify at least one of the broker, the trustee, and/or the insurer indicating that the one or more investors have deceased and the unpledged shares have been redeemed for IRUs.

Moving on to FIGS. 6A and 6B, shown is a sequence diagram (which starts at FIG. 6A and are continued to FIG. 6B) that provides at least one example of the interactions between the trustee (the trustee device 112), the insurance company (the insurer device 109), the investor (the investor device 106), the financial advisor (the FA device 121), the LifeDX software (the Application program 151 on the computing environment 103), the broker/dealer (the broker device 118), and the clearing house (the clearing house device 115). The sequence diagram of FIGS. 6A and 6B provide merely an example of the many different types of functional arrangements that can be employed by the trustee (the trustee device 112), the insurance company (the insurer device 109), the investor (the investor device 106), the financial advisor (the FA device 121), the LifeDX software (the Application program 151 on the computing environment 103), the broker/dealer (the broker device 118), and the clearing house (the clearing house device 115). As an alternative, the sequence diagram of FIGS. 6A and 6B can be viewed as depicting examples of elements of one or more method implemented within the network environment 100.

Beginning at FIG. 6A, at block 603, the FA (on the FA device 121) can review various factors and then, on behalf of the investor, can determine whether to activate income through online portal, resulting in the estimated lifetime income for pledged shares. Continuing at block 606, the FA (on the FA device 121) along with the investor can decide whether to proceed. If the FA or the investor decide to not proceed, the process returns to block 603. If the FA or the investor decide to proceed, the process proceeds to block 609. At block 609, the FA (on the FA device 121) can warn an investor that selling pledged shares may reduce future guaranteed income for the investor, and the FA can approve the transaction on behalf of the investor (shareholder). Next, at block 612, the FA device 121 can send demographic information (PII), cost basis data on shares to be pledged and income choice (single or joint) to the application program 151 on the computing environment 103. Next, at block 615 the application program 151 can receive information and calculate an amount of lifetime income due to the investor’s information received at block 612.

At block 618, the application program 151 can communicate calculated amount of lifetime income to the investor (investor device 106) and FA (FA device 121). As a result of block 618, both blocks 621 and 624 can be performed either in parallel or sequentially. At block 621, the application program 151 can communicate the calculated amount of lifetime income to an insurance company (insurer device 109). At block 624 the application program 151 can set up pledged shares and income reference units (IRUs). Following block 624, the process can continue to either block 627 or block 642 (on FIG. 6B), or both in parallel or sequentially. Continuing to block 627, the application program 151 can communicate to the trustee (at the trustee device 112) to issue income reference units (IRUs) to an investor’s account through a clearing house (clearing house device 115) (e.g., NSCC – National Securities Clearing Corporation, etc.). The trustee device 112, at block 630, can communicate to a clearing house device 115 to issue income reference units (IRUs) to the investor. Following block 630, the process continues to block 636 on FIG. 6B.

Continuing to FIG. 6B, the clearing house device 115 can receive the information from the trustee device 112 sent from block 630 and, at block 636, can send a number of IRUs issue to a broker/dealer (at the broker device 118). The process continues to block 639, where the broker/dealer (at the broker device 118) receives the IRUs share confirmation from the Clearing house (at the clearing house device 115). The process from block 639 can continue to block 657.

As previously describe from block 624 (FIG. 6A), block 624 (FIG. 6A) can continue to block 642. At block 642, the application program 151 at the computing environment 103 can create an investor profile based on PII demographic information, where the investor profile is associated with the pledged shares for that profile. Subsequent to block 642, the process can move to either of blocks 645 and/or 651, in parallel or sequentially. At block 645, the application program 151 can communicate to the insurer device 109 the investor profile based on the demographic information, the IRUs, and the record of pledged shares that have been created. In response to block 645, the insurer device 109 at block 648 can receive confirmation from the computing environment 103 and create appropriate investor information and reserves.

Also continuing from block 642, the process can continue to block 651 where the application program 151 of the computing environment 103 can send pledged share information to a broker device 118. Continuing to block 654, the broker device 118 can reflect pledged share identifier to the investor device 106. From both blocks 639 and/or 654, the process can continue to block 657, where the investor device 106 can verify that the IRUs and pledged shares are reflected in their account. Subsequent to block 657, the process of FIGS. 6A and 6B can come to an end.

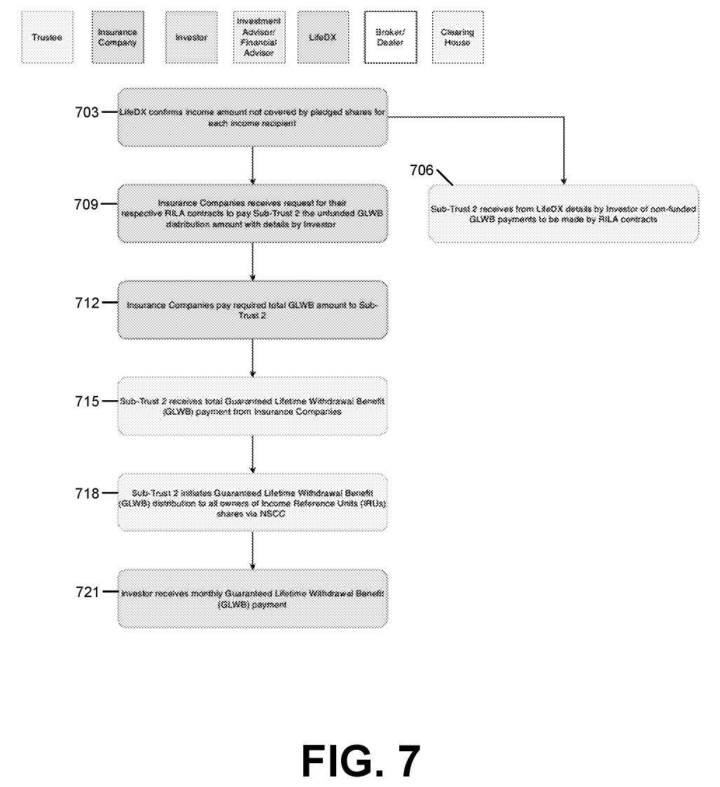

Moving on to FIG. 7, shown is a sequence diagram that provides at least one example of the interactions between the trustee (the trustee device 112), the insurance company (the insurer device 109), the investor (the investor device 106), and the LifeDX software (the Application program 151 on the computing environment 103). The sequence diagram of FIG. 7 provide merely an example of the many different types of functional arrangements that can be employed by the trustee (the trustee device 112), the insurance company (the insurer device 109), the investor (the investor device 106), and the LifeDX software (the Application program 151 on the computing environment 103). As an alternative, the sequence diagram of FIG. 7 can be viewed as depicting examples of elements of one or more method implemented within the network environment 100.

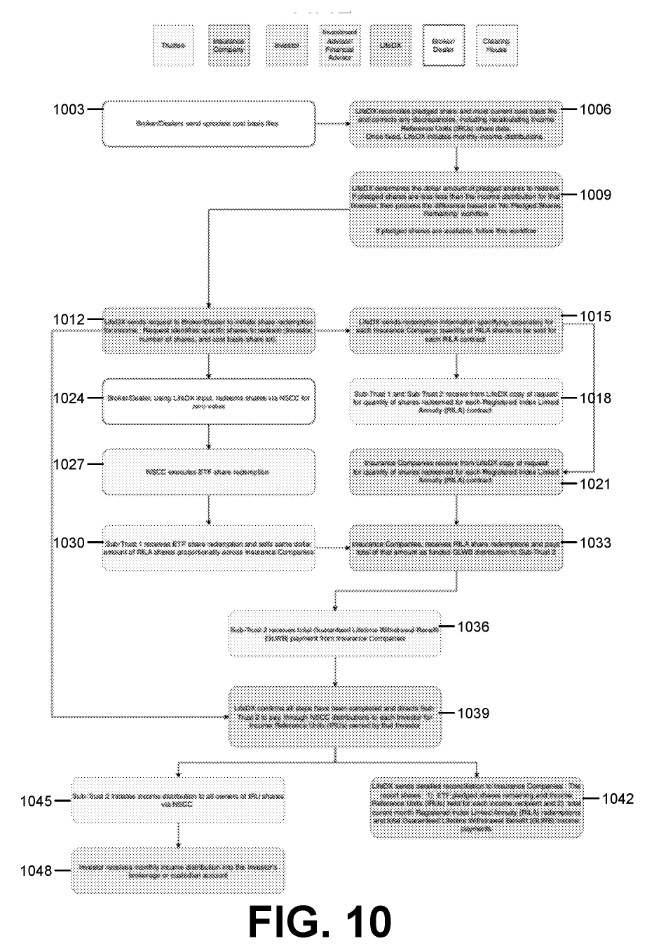

Beginning at FIG. 7, the program application 151 of the computing environment 103 can confirm income amounts not covered by pledged shares for each income recipient. For partial amounts, the programming application 151 can send the amount covered by the remaining pledged shares to block 1012 of FIG. 10. The sequence from block 703 can continue to both blocks 706 and/or 709, either in parallel or sequentially. At block 706, the trustee device 112 can receive details regarding an investor of a non-funded guaranteed lifetime withdrawal benefit (GLWB) to be made by registered index linked annuity (RILA) contracts. Continuing from block 703 to block 709, the insurer device 109 can receive a request for a RILA contract to pay a trustee device 112 the unfunded GLWB distribution amount with details by the investor. Continuing from block 709 to block 712, the insurer device 106 can effectuate a payment required by the GLWB in the amount identified to the trustee device 112, which at block 715 the trustee device 112 can receive. At block 718, the trustee device 112 can initiate a GLWB distribution to all owners of IRU shares via a clearing house device 115. In response, the investor device 106, at block 721, can receive monthly GLWB payment. Subsequent to block 721, the process of FIG. 7 can come to an end.

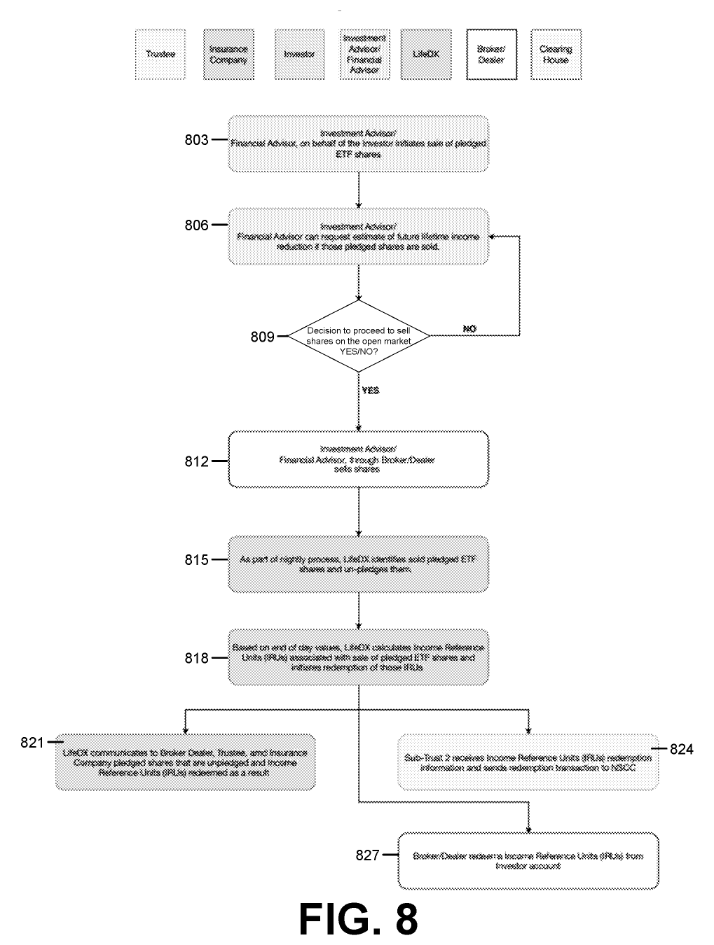

Moving on to FIG. 8, shown is a sequence diagram that provides at least one example of the interactions between the financial advisor (the FA device 121), the LifeDX software (the Application program 151 on the computing environment 103), and the broker/dealer (the broker device 118). The sequence diagram of FIG. 8 provides merely an example of the many different types of functional arrangements that can be employed by the financial advisor (the FA device 121), the LifeDX software (the Application program 151 on the computing environment 103), and the broker/dealer (the broker device 118]. As an alternative, the sequence diagram of FIG. 8 can be viewed as depicting examples of elements of one or more method implemented within the network environment 100.

Beginning at block 803 at FIG. 8, an FA can initiate a sale of pledged ETF shares. In at least some embodiments, the FA can first receive approval from the investor to initiate the sale of pledged ETF shares. In various embodiments, the FA can initiate the sale of pledged ETF shares without approval from the investor. At block 806, the FA can receive estimated income for pledged shares and warn an investor that selling pledged shares may reduce future guaranteed income. Continuing to block 809, the FA can decide whether to sell shares on the open market. If the FA decides to not proceed to sell their shares on the open market, the process can return to block 806. If the FA decides to proceed to sell their shares on the open market, the process can continue to blocks 812-821 starting with block 812.

At block 812, if the FA decides to proceed selling the shares on the open market, the FA device 121 can direct the broker device 118 to sell shares and send transaction details to the application program 151 at the computing environment 103. Continuing to block 815, as part of a nightly process, the application program 151 can identify sold pledged ETF shares and un-pledge them. Continuing to block 818, the application program 151 can calculate IRUs associated with sale of pledged ETF shares and initiates a redemption of those IRUs through the clearing house device 115 based at least on the end of day values. From block 818, the process can proceed to one or more of blocks 821, 824, and/or 827, which can be executed in parallel or sequentially in any order. At block 821, the application program can communicate to a broker device 118, trustee device 112, insurer device 109 that the pledged shares are now unpledged and IRUs are redeemed as a result. At block 824, the trustee device 121 can receive IRUs redemption information and can subsequently send the redemption transaction to the clearing house device 115. At block 827, at least one of the broker device 118 or the trustee device 121 can redeem IRUs from an investor account. Subsequently, the process of FIG. 8 can come to an end.

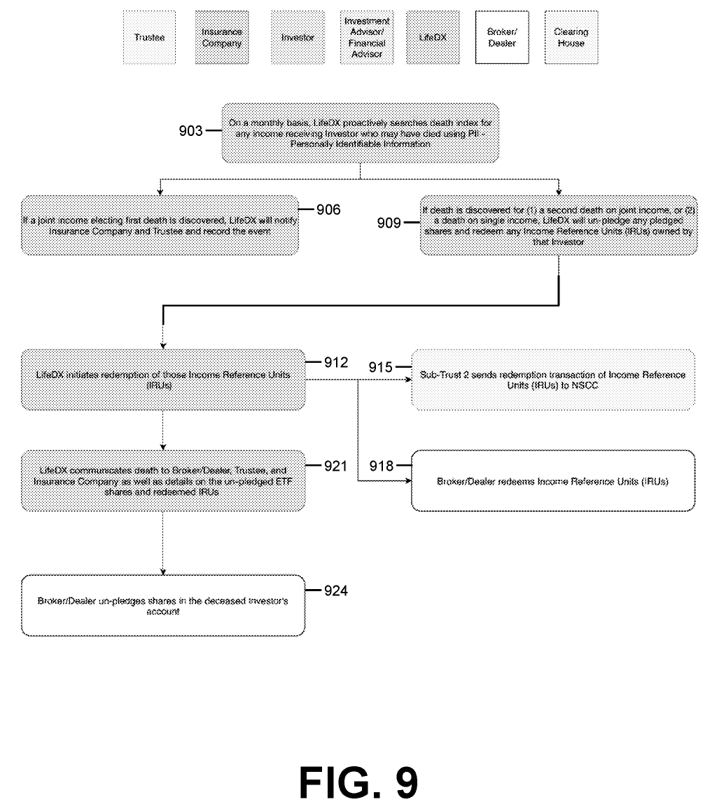

Moving on to FIG. 9, shown is a sequence diagram that provides at least one example of the interactions of the LifeDX software (the Application program 151 on the computing environment 103). The sequence diagram of FIG. 9 provides merely an example of the many different types of functional arrangements that can be employed by the LifeDX software (the Application program 151 on the computing environment 103). As an alternative, the sequence diagram of FIG. 9 can be viewed as depicting examples of elements of one or more method implemented within the network environment 100.

Beginning at block 903 of FIG. 9, the application program 151 can proactively search a death index for any income receiving investor who may have died based at least on Personally Identifying Information. In some embodiments, this can be performed on an hourly, daily, month, or yearly basis. Continuing to block 906, the application program 151 can notify the insurer device 109 and the trustee device 112 if an income electing death is discovered. However, if a second death on joint income electing or a death on a single income electing plan is discovered, then at block 909, the application program 151 can un-pledge any pledged shares and redeem any IRUs owned by that investor. The application program 151 can initiate a redemption of those IRUs at block 912. From block 912, the process can proceed to one or more of blocks 915, 918, and/or 921, either in parallel or sequentially. At block 915, the trustee device 112 can send a redemption transaction of IRUs to the clearing house device 115. At block 918, at least one of the broker device 118 or the trustee device 121 can redeem the IRUs. At block 921, the application program 151 can communicate the death to one or more of the broker device 118, the trustee device 112, the insurer device 109, as well as any details on the un-pledged ETF shares and redeemed IRUs. Continuing from block 921, at block 924, the broker device 118 can un-pledge shares in the deceased investor’s account. Subsequently, the process of FIG. 9 can come to an end.

Moving on to FIG. 10, shown is a sequence diagram that provides at least one example of the interactions between the trustee (the trustee device 112), the insurance company (the insurer device 109), the investor (the investor device 106), the financial advisor (the FA device 121), the LifeDX software (the Application program 151 on the computing environment 103), the broker/dealer (the broker device 118), and the clearing house (the clearing house device 115). The sequence diagram of FIG. 10 provides merely an example of the many different types of functional arrangements that can be employed by the trustee (the trustee device 112), the insurance company (the insurer device 109), the investor (the investor device 106), the financial advisor (the FA device 121), the LifeDX software (the Application program 151 on the computing environment 103), the broker/dealer (the broker device 118), and the clearing house (the clearing house device 115). As an alternative, the sequence diagram of FIG. 10 can be viewed as depicting examples elements of one or more method implemented within the network environment 100.

Beginning with block 1003, the broker device 118 can send one or more “up-to-date” cost basis files to the application program 151 at the computing environment 103. Continuing to block 1006, the application program 151 can reconcile the pledged shares and most current cost basis file and correct for any discrepancies (in available). For example, the application program 151 can recalculate IRU share data. At block 1009, the application program 151 can determine the dollar amount of pledged shares to redeem. If pledged shares are less than the income distribution for that investor, then the process can proceed to block 703 of FIG. 7, otherwise the process proceeds to block 1012. At block 1012, the application program 151 can send a request to a broker device 118 to initiate share redemption for income. The request can identify specific shares to redeem (e.g., investor, number of shares, and cost basis share lot, etc.). From block 1012, the process can proceed to any one of blocks 1015, 1024, and/or 1039, which can be perform in parallel, or sequentially.

At block 1015, the application program 151 can send redemption information specifying (separately for each insurance company) a quantity of RILA shares to be sold for each RILA contract. From block 1015, the process can proceed to any one of blocks 1018 and/or 1021, performed in parallel or sequentially. At block 1018, the trustee devices 112 can receive a copy of request for a quantity of shares to be redeemed for each RILA contract. At block 1021, the insurer device 109 can receive a copy of request for quantity of shares redeemed for each RILA contract. From block 1021, the process can proceed to block 1033.

Continuing from block 1012 to block 1024, the broker device 118 can redeem shares via the clearing house for zero value. Continuing to block 1027, the clearing house device 115 can execute the ETF share redemption. Continuing to block 1030, the trustee device 112 can receive ETF share redemption and sell same dollar amount of RILA shares across the insurers (at the insurer devices 109). In some embodiments, the sale of the same dollar amount of RILA shares can be sold proportionally.

At block 1033, the insurer device 109 can receive the RILA share redemptions and pays a total of that amount as funded GLWB distribution to the Trustee device 112. The process of block 1033 can proceed to block 1036 where the trustee device 112 can receive the total GLWB payment from the insurance companies. From either block 1012 or block 1036, the process can continue to block 1039, where the application program 151 can confirm all the steps have been completed and directs the trustee device 112 to pay, through the clearing house device, to each investor for IRUs owned by that investor. From block 1039, the process can proceed to any one of blocks 1042 and/or 1045, which can be perform in parallel, or sequentially. At block 1042, the application program can send a detailed reconciliation to the insurer device 109. The reconciliation report can show at least the ETF pledged shares remaining and IRUs held for each income recipient, and a total current month RILA redemption amount and total GLWB income payments amount. Continuing to block 1045, the trustee device 112 can initiate the income distribution to all owners of IRU shares via the clearing house device 115, which at block 1048, at least one of the broker, the investor, or holders of the investor’s financial account(s) can receive monthly income distribution into the investor’s brokerage or custodian account. Subsequently, the process of FIG. 10 can end.

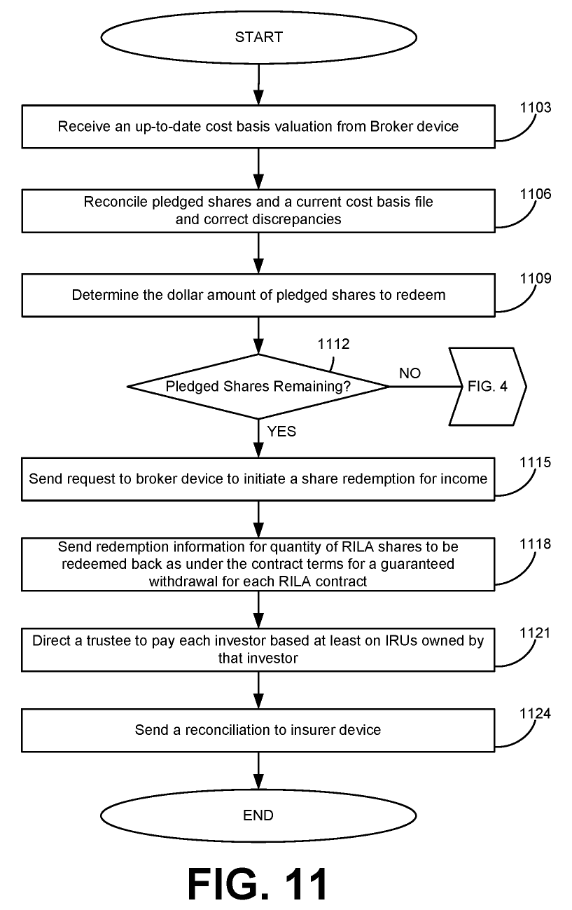

Referring next to FIG. 11, shown is a flowchart that provides one example of the operator of a portion of the application program 151 according to various embodiments of the present disclosure. The flowchart of FIG. 11 provides merely an example of the many different types of functional arrangements that can be employed to implement the operation of the depicted portion of the application program 151. As an alternative, the flowchart of FIG. 11 can be viewed as depicting an example of elements of a method implemented within the network environment 100.

To begin, at block 1103, the application program 151 can receive an up-to-date cost basis valuation from a broker device 118. At block 1106, the application program 151 can reconcile pledged shares and a current cost basis file and correct any discrepancies. At block 1109, the application program 151 can determine the dollar amount of pledged shares to redeem. At block 1112, the application program 151 can determine if there are any pledged shares remaining. If not, the process can proceed to block 403 of FIG. 4, otherwise, the process can continue to block 1115. At block 1115, the application program 151 can send a request to the broker device 118 to initiate a share redemption for income. Continuing to block 1118, the application program 151 can send the redemption information for quantity of RILA shares to be redeemed back as under the contract terms for a guaranteed withdrawal for each RILA contract. Next, at block 1121, the application program 151 can direct a trustee to pay each investor based at least on IRUs owned by that investor. Finally, at block 1124, the application program 151 can send a reconciliation to an insurer device.

What is claimed is:

1. A method, comprising:
calculating an amount of lifetime income;
sending the amount of lifetime income to one of the investor, the financial advisor, or the insurance company;
sending notification to trustee to issue income reference units (IRUs) through a clearing house;
creating pledged shares associated with an investor and investor profile;
sending the pledged share information to a broker, wherein the pledged share information is associated with the pledged shares; and
sending the investor profile, the IRUs, and the pledged share information to an insurer.

2. The method of claim 1, further comprising receiving at least one of personally identifiable information (PII), cost basis data on shares to be pledged, and income choice.

3. The method of claim 2, wherein calculating the amount of lifetime income is based on the at least one of the PII, the cost basis data on the shares to be pledged, and the income choice.

4. The method of claim 2, wherein creating the pledged shares associated with the investor and the investor profile is further based on the at least at least one of the PII, the cost basis data on the shares to be pledged, and the income choice.

5. The method of claim 1, further comprising preparing to generate the pledged shares and the IRUs.

6. The method of claim 5, wherein preparing to generate the pledged shares and the IRUs further comprises:
calculating a number of IRUs based on a calculated amount of lifetime income; and
establishing a connection to the trustee through the clearing house.

7. The method of claim 1, wherein the pledged shares are represented as one or more tokens offered over a blockchain.

8. An apparatus comprising:
one or more processors; and
a memory storing processor-executable instructions that, when executed by the one or more processors, cause the apparatus to:
calculate an amount of lifetime income;
send the amount of lifetime income to one of the investor, the financial advisor, or the insurance company;
send notification to a trustee to issue income reference units (IRUs) through a clearing house;
create pledged shares associated with an investor and an investor profile;
send pledged share information to a broker, wherein the pledged share information is associated with the pledged shares; and
send the investor profile, the IRUs, and the pledged share information to an insurer.

9. The apparatus of claim 8, wherein the processor-executable instructions, when executed by the one or more processors, further cause the apparatus to:
receive at least one of personally identifiable information (PII), cost basis data on shares to be pledged, and income choice.

10. The apparatus of claim 9, wherein the processor-executable instructions that calculate the amount of lifetime income, when executed by the one or more processors, further cause the apparatus to calculate the amount of lifetime income based on the at least one of the PII, the cost basis data on the shares to be pledged, and the income choice.

11. The apparatus of claim 9, wherein the processor-executable instructions that create the pledged shares associated with the investor and the investor profile, when executed by the one or more processors, further cause the apparatus to create the pledged shares based on the at least one of the PII, the cost basis data on the shares to be pledged, and the income choice.

12. The apparatus of claim 8, wherein the processor-executable instructions, when executed by the one or more processors, further cause the apparatus to:
prepare to generate the pledged shares and the IRUs.

13. The apparatus of claim 12, wherein the processor-executable instructions that prepare to generate the pledged shares and the IRUs, when executed by the one or more processors, further cause the apparatus to:
calculate a number of IRUs based on a calculated amount of lifetime income; and
establish a connection to the trustee through the clearing house.

14. The apparatus of claim 8, wherein the processor-executable instructions that calculate the amount of the lifetime income, when executed by the one or more processors, further cause the apparatus to calculate the amount of the lifetime income based on an amount associated with the pledged shares.

15. One or more non-transitory computer-readable media storing processor-executable instructions that, when executed by at least one processor, cause the at least one processor to:
calculate an amount of lifetime income;
send the amount of lifetime income to one of the investor, the financial advisor, or the insurance company;
send notification to a trustee to issue income reference units (IRUs) through a clearing house;
create pledged shares associated with an investor and an investor profile;
send pledged share information to a broker, wherein the pledged share information is associated with the pledged shares; and
send the investor profile, the IRUs, and the pledged share information to an insurer.

16. The one or more non-transitory computer-readable media of claim 15, wherein the processor-executable instructions, when executed by the at least one processor, further cause the at least one processor to:
receive at least one of personally identifiable information (PII), cost basis data on shares to be pledged, and income choice.

17. The one or more non-transitory computer-readable media of claim 16, wherein calculating the amount of lifetime income is based on the at least one of the PII, the cost basis data on the shares to be pledged, and the income choice.

18. The one or more non-transitory computer-readable media of claim 16, wherein creating the pledged shares associated with the investor and the investor profile is further based on the at least one of the PII, the cost basis data on the shares to be pledged, and the income choice.

19. The one or more non-transitory computer-readable media of claim 15, wherein the processor-executable instructions, when executed by the at least one processor, further cause the at least one processor to:
prepare to generate the pledged shares and the IRUs.

20. The one or more non-transitory computer-readable media of claim 15, wherein calculating the amount of the lifetime income is based on an amount associated with the pledged shares.
